(19) United States
(12) Patent Application Publication
(10) Pub. No.: US 2018/0275603 A1
(43) Pub. Date: Sep. 27, 2018

(54) COMPOSITION FOR HOLOGRAM RECORDING MATERIAL, HOLOGRAM RECORDING MATERIAL, AND HOLOGRAM RECORDING MEDIUM

(71) Applicant: FUJI XEROX Co., Ltd., Tokyo (JP)

(72) Inventors: Takashi KIKUCHI, Kanagawa (JP); Masahiro IGUSA, Kanagawa (JP); Shigetoshi NAKAMURA, Kanagawa (JP); Yasuhiro OGASAWARA, Kanagawa (JP); Takashi FUJIMOTO, Kanagawa (JP); Jiro MINABE, Kanagawa (JP)

(73) Assignee: FUJI XEROX Co., Ltd., Tokyo (JP)

(21) Appl. No.: 15/903,434

(22) Filed: Feb. 23, 2018

(30) Foreign Application Priority Data
Mar. 24, 2017 (JP) 2017-060098

(51) Int. Cl. G03H 1/02

(52) U.S. Cl. CPC G03H 1/02; G03H 2260/12; G03H 2001/0264

(57) ABSTRACT

A composition for a hologram recording material includes a binder precursor containing a compound having a structure represented by formula A below, a polymerizable monomer and a photopolymerization initiator.

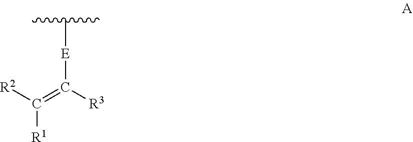

In the formula A, R¹ to R³ each represent a hydrogen atom or a substituent, E represents a divalent electron attracting group, a wavy line portion represents a bonding site with another structure, and when E is —C(═O)O—, R³ is not an alkyl group.

### CROSS-REFERENCE TO RELATED APPLICATIONS

This application is based on and claims priority under 35 USC 119 from Japanese Patent Application No. 2017-060098 filed Mar. 24, 2017.

### (i) TECHNICAL FIELD

The present invention relates to compositions for hologram recording materials, hologram recording materials, and hologram recording media.

### (ii) RELATED ART

Holograms are produced by recording interference fringes between two types of coherent lights, called object light and reference light, on photosensitive materials, and when the resultant photosensitive materials are irradiated with light whose wavelengths and directions are close to the same as that of the reference light, light flux having information close to the same as the object light are generated from the photosensitive materials, that is, reconstruction is performed.

A three-dimensional hologram is widely known as an application example of hologram technology, in which a three-dimensional object is irradiated with coherent light, and interference fringes produced by interference between coherent light reflected from the object and reference light are recorded on a photosensitive material. When the recorded photosensitive material is irradiated with light close to the same of the reference light used for recording, exactly the same three-dimensional image as the object is reproduced and appears at the original position of the object.

Besides the three-dimensional hologram, the hologram technology is applied to a three-dimensional image display element, an optical element, and the like, which are referred to as holographic optical elements (HOE). Also, it is expected to apply to the field of large-capacity memory in which digital information is recorded/reproduced, that is, the field of holographic information recording.

An amount of refractive-index modulation (Δn) is known as one of the indexes indicating the characteristics of holographic materials. The brightness of a holographic image increases with increasing Δn value.

### SUMMARY

According to an aspect of the invention, there is provided compositions for hologram recording materials, the compositions including a binder precursor containing a compound having a structure represented by formula A below, a polymerizable monomer, and a photopolymerization initiator.

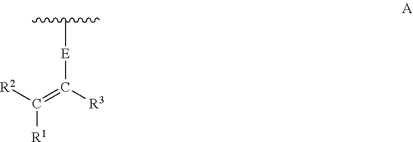

In the formula A, R¹ to R³ each represent a hydrogen atom or a substituent, E represents a divalent electron attracting group, a wavy line portion represents a bonding site with another structure, and when E is —C(═O)O—, R³ is not an alkyl group.

### DETAILED DESCRIPTION

Exemplary embodiments of the present invention are described in detail below.

### (Composition for Hologram Recording Material)

A hologram recording material is produced by, for example, using a composition containing a binder precursor, a polymerizable monomer, and a photopolymerization initiator. The composition is applied on a substrate, dried if required, and then heated to polymerize the components contained in the binder precursor, thereby producing the hologram recording material.

A hologram is produced by interference exposure of the resultant hologram recording material.

In the interference exposure, polymerization of the polymerizable monomer is started by the action of the photopolymerization initiator in a portion where light is strengthened by interference, and a concentration gradient of the polymer occurs in the hologram recording material. As a result, the polymerizable monomer etc. diffuse and move from a weak-light portion to a strong-light portion. Therefore, a concentration distribution of the polymer produced by polymerization of the polymerizable monomer occurs in the hologram recording medium, depending on the strength of interfering light (a destructive portion and a constructive portion in interference fringes). The concentration distribution appears as a refractive-index difference (refractive-index modulation (Δn)) in the hologram recording medium, thereby generating a holographic image.

A hologram recording medium having excellent Δn can be produced by using a composition for a hologram recording material according to an exemplary embodiment of the present invention.

Although the detailed mechanism of this effect is not known, it is supposed as follows.

The composition for a hologram recording material according to the exemplary embodiment includes a binder precursor (hereinafter referred to as a “specific binder precursor”) containing a compound having a structure represented by formula A, a polymerizable monomer, and a photopolymerization initiator.

The composition for a hologram recording material according to the exemplary embodiment is applied on, for example, a substrate and then heated to polymerize the components contained in the specific binder precursor, thereby producing a hologram recording material containing a binder (hereinafter referred to as a “specific binder”) having a structure represented by the formula A according to an exemplary embodiment of the present invention.

It is considered that interference exposure of the hologram recording material according to the exemplary embodiment causes not only polymerization of the polymerizable monomer but also polymerization of the polymerizable monomer and the specific binder or polymerization of the specific binder.

As described above, a refractive-index difference in the hologram recording medium is considered to be produced by dispersion and movement of the polymerizable monomer during polymerization. In this case, the polymer produced by polymerization of the polymerizable monomer preferably little diffuses and moves. When the polymer easily diffuses and moves, the polymer diffuses from a position with high interference intensity of light, and thus the concentration of the polymer at a position with high interference intensity of light is decreased, thereby decreasing Δn.

A composition described in Japanese Unexamined Patent Application No. 2008-268520 forms a binder having an alkenyl ether group. A composition described in Japanese Unexamined Patent Application No. 2001-109360 forms an allyl prepolymer having at least one allyl group.

However, an alkenyl group and an allyl group have low polymerizability (particularly, radical polymerizability). Therefore, when each of the compositions or hologram recording materials described in Japanese Unexamined Patent Application Nos. 2008-268520 and 2001-109360 is used, a polymer is not easily fixed at a position with high interference intensity of light and is considered to have small Δn as compared with use of the composition for a hologram recording material according to the exemplary embodiment.

Further, in order to improve Δn of the hologram recording medium, it is desired to increase the amount of the monomer polymerized in a portion where interfering light is strengthened by using a polymerizable monomer having high diffusibility as the polymerizable monomer.

However, when the polymerizable monomer with high diffusibility is used, the polymer produced by polymerization of the polymerizable monomer also has high diffusibility, and thus Δn may be decreased.

According to the exemplary embodiment, even when the polymerizable monomer having high diffusibility is used, diffusion of the polymer little occurs due to fixing of the polymer to the binder, and thus the hologram recording medium with large Δn can be produced.

<Measurement of Diffraction Efficiency and Δn>

The diffraction efficiency and Δn of the hologram recording medium according to the exemplary embodiment are evaluated by referring to a measurement method and apparatus described in J. Photopolym. Sci. Technol., Vol. 22, No. 2, p. 257, 2009.

A diffracted light quantity A and a transmitted light quantity B are determined by the obtained light quantity curve, and diffraction efficiency η is calculated by formula 1 below.

Diffraction efficiency η=A/(A+B)×100(%) Formula 1:

Then, the refractive-index modulation (Δn) is calculated by a Kogelnik theoretical formula below using the value of diffraction efficiency η.

η=tan h²(π(Δn)d/λ cos θ₀) Kogelnik theoretical formula:

In the formula, η is the diffraction efficiency, d is the thickness of a hologram recording layer, λ is the wavelength of recording laser, and θ₀ is an incident angle of recording laser beam in the hologram recording layer.

The thickness d of the hologram recording layer is determined by subtracting the thicknesses of the substrate and a protective film from the total thickness of the hologram recording medium.

Each of the components in the composition for a hologram recording material according to the exemplary embodiment is described below.

### <Specific Binder Precursor>

The specific binder precursor is a compound group containing a compound serving as a binder in a hologram recording material.

Examples of the specific binder precursor include, but are not limited to, a combination of a polyol compound and a polyisocyanate compound which form polyurethane as a binder, a combination of a polyol compound and a polycarboxylic acid compound which form polyester, a combination of a polyamine compound and a polyisocyanate compound which form polyamide, a combination of a carboxylic anhydride and a polyamine compound which form polyimide, and the like. The binder precursor preferably contains a polyol compound and a polyisocyanate compound, and preferably contains a diol compound and a diisocyanate compound.

In this disclosure, an isocyanate group may be blocked by a known blocking agent.

### [Compound Having Structure Represented by Formula A]

The binder precursor contains a compound having a structure represented by formula A below.

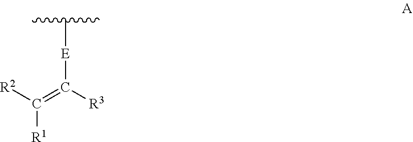

In the formula A, R¹ to R³ each represent a hydrogen atom or a substituent, E represents a divalent electron attracting group, a wavy line portion represents a bonding site with another structure, and when E is —C(═O)O—, R³ is not an alkyl group.

In the formula A, R¹ represents a hydrogen atom or a substituent, and from the viewpoint of improving Δn, R² preferably represents a hydrogen atom or an alkyl group having 1 or more and 10 or less carbon atoms, and more preferably represents a hydrogen atom.

In the formula A, R² represents a hydrogen atom or a substituent, and from the viewpoint of improving Δn, R² preferably represents a hydrogen atom or an alkyl group having 1 or more and 10 or less carbon atoms, and more preferably represents a hydrogen atom.

In the formula A, R³ represents a hydrogen atom or a substituent, and from the viewpoint of improving Δn, R³ preferably represents a hydrogen atom or an alkyl group having 1 or more and 10 or less carbon atoms, more preferably represents a hydrogen atom or a methyl group, and still more preferably represents a hydrogen atom.

In the formula A, E represents a divalent electron attracting group, preferably represents —C(═O)O—, —C(═O)NR^{N}—, —S(═O)₂—, or an arylene group, and more preferably represents —C(═O)O—. When E represents —C(═O)O— or —C(═O)NR^{N}—, a carbon atom to which an oxygen atom contained in —C(═O)O— or —C(═O)NR^{N}— is bonded is preferably bonded directly to a carbon atom to which R³ contained in the formula A is bonded. R^{N} represents a hydrogen atom or an alkyl group, preferably represents a hydrogen atom or an alkyl group having 1 or more and 4 or less carbon atoms, and more preferably represents a hydrogen atom.

From the viewpoint of reactivity, a structure represented by the formula A is a (meth)acryloxy group or a (meth)acrylamide group, preferably an acryloxy group or acrylamide group, and still more preferably an acryloxy group.

In the exemplary embodiment, the term “(meth)acryloxy group” represents an acryloxy group or a methacryloxy group. The same content applies to a (meth)acrylamide group, a (meth)acrylic acid ester compound, or the like.

Examples of the compound having a structure represented by the formula A include a polyol compound, a polyamine compound, a polyisocyanate compound, and the like.

The compound having a structure represented by the formula A may be, for example, a monomer, a prepolymer, that is, a dimer, a trimer, or an oligomer, or a mixture or (co)polymer thereof.

The binder precursor preferably contains a polyol compound and a polyisocyanate compound at least one of which has the structure represented by the formula A, and the polyol compound more preferably has the structure represented by the formula A. The polyol compound still more preferably has at least two hydroxyl groups and at least one (meth)acryloxy group and particularly preferably has at least two hydroxyl groups and at least one acryloxy group.

Examples of the polyol compound having the structure represented by the formula A include, but are not limited to, a compound produced by reacting a polyol compound with a compound having an epoxy group and a structure represented by the formula A, a partial ester compound of a polyol compound and an unsaturated carboxylic acid, and a compound produced by reacting an amino group of a compound having plural hydroxyl groups and amino groups with a compound having an isocyanate group and a structure represented by the formula A.

Specific examples of the polyol compound having the structure represented by the formula A include, but are not limited to, those described below. In the examples, R represents a hydrogen atom or a methyl group.

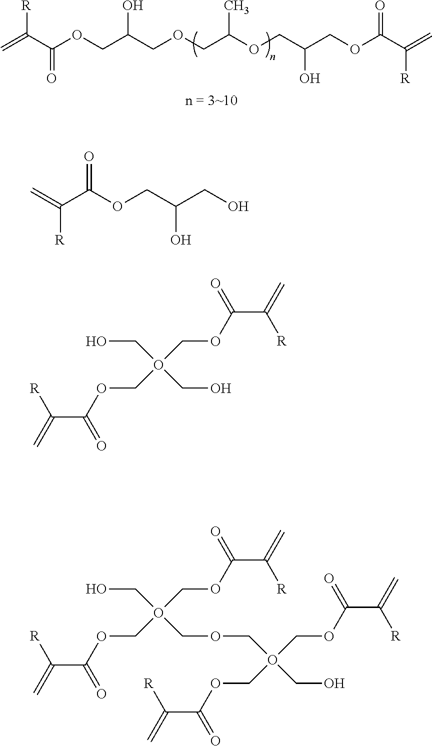

The content of the compound having the structure represented by the formula A is preferably 0.01% by mass or more and 50% by mass or less, and more preferably 0.1% by mass or more and 10% by mass or less relative to the total mass of the specific binder precursor.

### (Other Polyol Compound)

The specific binder precursor may contain a polyol compound (hereinafter referred to as an “other polyol compound”) not having the structure represented by the formula A.

The other polyol compound is preferably a diol compound.

Examples of the other polyol compound include low-molecular-weight polyols, polyether polyols, polyester polyols, polycaprolactones, polycarbonate diols, and the like.

Also, the other polyol compound is not particularly limited but is, for example, preferably a polyol compound having an alkylene glycol structure or a polyalkylene glycol structure and more preferably a compound having a polyethylene glycol structure or a polypropylene glycol structure.

Examples of the low-molecular-weight polyols include ethylene glycol, propylene glycol, cyclohexanedimethanol, 3-methyl-1,5-pentanediol, glycerin, and trimethylolpropane, ethylene oxide (EO)-modified products or propylene oxide (PO)-modified products thereof, and the like.

Examples of the polyether polyols include polyethylene glycol, polypropylene glycol, polytetramethylene glycol, and the like.

Examples of the polyester polyols include reaction products of ethylene glycol, propylene glycol, cyclohexanedimethanol, and 3-methyl-1,5-pentanediol with an acid component such as a dibasic acid such as adipic acid, succinic acid, phthalic acid, hexahydrophthalic acid, or terephthalic acid or an anhydride thereof.

### [Other Polyisocyanate Compound]

The specific binder precursor may contain a polyisocyanate compound (hereinafter referred to as an “other polyisocyanate compound”) not having the structure represented by the formula A.

The other polyisocyanate compound is preferably a diisocyanate compound.

Examples of the other polyisocyanate compound include tolylene diisocyanate, 4,4′-diphenylmethane diisocyanate, 4,4′-dicyclohexylmethane diisocyanate, hexamethylene diisocyanate, isophorone diisocyanate, and the like, biurets, isocyanurates, adducts, or prepolymers of these isocyanate compounds, and the like.

### (Other Polyamine Compound)

The specific binder precursor may contain a polyamine compound (hereinafter referred to as an “other polyamine compound”) not having the structure represented by the formula A.

The other polyamine compound is preferably a diamine compound.

Examples of the other polyamine compound include 2,7-diamino-9H-fluorene, 3,6-diaminoacridine, acriflavine, acridine yellow, 2,2-bis(4-aminophenyl)hexafluoropropane, 4,4′-diaminobenzophenone, bis(4-aminophenyl)sulfone, 4,4′-diaminodiphenyl ether, bis(4-aminophenyl) sulfide, 1,1-bis(4-aminophenyl)cyclohexane, 4,4′-diaminodiphenylmethane, 3,3′-diaminodiphenylmethane, 3,3′-diaminobenzophenone, 4,4′-diamino-3,3′-dimethyldiphenylmethane, 4-(phenyldiazenyl)benzene-1,3-diamine, 1,5-diaminonaphthalene, 1,3-phenylenediamine, 2,4-diaminotoluene, 2,6-diaminotoluene, 1,8-diaminonaphthalene, 1,3-diaminopropane, 1,3-diaminopentane, 2,2-dimethyl-1,3-propanediamine, 1,5-diaminopentane, 2-methyl-1,5-diaminopentane, 1,7-diaminoheptane, N,N-bis(3-aminopropyl)methylamine, 1,3-diamino-2-propanol, diethylene glycol bis(3-aminopropyl) ether, m-xylylenediamine, tetraethylenepentamine, 1,3-bis(aminomethyl)cyclohexane, benzoguanamine, 2,4-diamino-1, 3,5-triazine, 2,4-diamino-6-methyl-1,3,5-triazine, 6-chloro-2,4-diaminopyrimidine, 2-chloro-4,6-diamino-1,3,5-triazine, and the like.

A polyisocyanate synthesized by reacting any one of the polyamine compounds with phosgene or triphosgene may be used as the other polyisocyanate compound.

### (Characteristics of Specific Binder Precursor)

### —Refractive-Index Difference—

In the exemplary embodiment, from the viewpoint of increasing Δn, a refractive-index difference is preferably present between a specific binder formed by the specific binder precursor and a polymer produced by polymerizing a polymerizable monomer described below.

In the exemplary embodiment, the specific binder having a small refractive index and the polymer having a large refractive index may be used, or the specific binder having a large refractive index and the polymer having a small refractive index may be used. However, the specific binder having a small refractive index and the polymer having a large refractive index are preferably used.

When the specific binder having a small refractive index and the polymer having a large refractive index are used, the refractive index of the specific binder is preferably 1.30 or more and less than 1.55 and more preferably 1.35 or more and less than 1.50. The refractive index of the polymer produced by polymerizing a polymerizable monomer is preferably 1.50 or more and 1.80 or less and more preferably 1.55 or more and 1.70 or less.

When the specific binder having a large refractive index and the polymer having a small refractive index are used, the refractive index of the specific binder is preferably 1.45 or more and 1.80 or less and more preferably 1.50 or more and 1.65 or less. The refractive index of the polymer produced by polymerizing the polymerizable monomer is preferably 1.30 or more and less than 1.50 and more preferably 1.35 or more and less than 1.45.

The refractive index is measured by a Kalnew precision refractometer (KPR-3000 manufactured by Shimadzu Corporation) or the like using the specific binder or the polymer of the polymerizable monomer.

### —Content—

The content of the specific binder precursor is preferably 20% by mass or more and 95% by mass or less and more preferably 40% by mass or more and 90% by mass or less relative to the total solid content of the composition for a hologram recording material.

In the exemplary embodiment, the total solid content is the total amount of the components in the composition, excluding volatile components such as a solvent and the like.

### <Polymerizable Monomer>

The polymerizable monomer is not particularly limited, and a known polymerizable monomer can be used. The polymerizable monomer is preferably a radical polymerizable monomer and more preferably a radical polymerizable monomer having an ethylenically unsaturated group. From the viewpoint of polymerization reactivity, the polymerizable monomer is still more preferably a radical polymerizable monomer having an acryloxy group.

The polymerizable monomer may be either monofunctional or polyfunctional, but from the viewpoint of producing a hologram recording medium with large Δn, at least a polyfunctional polymerizable monomer is preferably contained.

Preferred examples of the polymerizable monomer include (meth)acrylic acid ester compounds, (meth)acrylamide compounds, styrene compounds, vinyl monomers, vinylnaphthalene compounds, and the like.

Among these, the (meth)acrylic acid ester compounds are preferred from the viewpoint of polymerization reactivity.

Examples of the (meth)acrylic acid ester compounds include (meth)acrylates of chain, branched chain, or cyclic alkyl alcohols such as methyl alcohol, ethyl alcohol, propyl alcohol, isopropyl alcohol, n-butyl alcohol, sec-butyl alcohol, tert-butyl alcohol, pentyl alcohol, neopentyl alcohol, hexyl alcohol, heptyl alcohol, octyl alcohol, nonyl alcohol, dodecyl alcohol, 2-methylbutyl alcohol, 3-methylbutyl alcohol, 2-ethylbutyl alcohol, 1,3-dimethylbutyl alcohol, 2-ethylhexyl alcohol, 2-methylpentyl alcohol, cyclohexyl alcohol, adamantly alcohol, isobornyl alcohol, dicyclopentanyl alcohol, tetrahydrofurfuryl alcohol, and the like; hydroxyalkyl (meth)acrylates such as 2-hydroxyethyl (meth)acrylate, 2-hydroxypropyl (meth)acrylate, and the like; (meth)acrylates having aromatic rings, such as phenyl (meth)acrylate, 4-methoxycarbonylphenyl (meth)acrylate, 4-ethoxycarbonylphenyl (meth)acrylate, 4-butoxycarbonylphenyl (meth)acrylate, 4-tert-butylphenyl (meth)acrylate, benzyl (meth)acrylate, 4-phenylethyl (meth)acrylate, 4-phenoxydiethylene glycol (meth)acrylate, 4-phenoxytetraethylene glycol (meth)acrylate, 4-phenoxyhexaethylene glycol (meth)acrylate, 4-biphenylyl (meth)acrylate, and the like; (meth)acrylates of phenol-alkylene oxide adducts, such as phenoxyethyl (meth)acrylate and the like or halogen-substituted products thereof (a halogen atom in the halogen-substituted products is preferably fluorine, chlorine, or bromine); (meth)acrylates containing an iron atom, such as ferrocenylmethyl (meth)acrylate, ferrocenylethyl (meth)acrylate, and the like; (meth)acrylate containing a halogen atom, such as trifluoroethyl (meth)acrylate, tetrafluoropropyl (meth)acrylate, heptadecafluorodecyl (meth)acrylate, octafluoropentyl (meth)acrylate, 2,3-dibromopropyl (meth)acrylate, and the like; (meth)acrylates containing a silicon atom, such as trimetoxysilylpropyl (meth)acrylate and the like; (meth)acrylates containing an epoxy group, such as glycidyl acrylate, glycidyl methacrylate, and the like; (meth)acrylates containing an amino group, such as N,N-dimethylaminoethyl (meth)acrylate, N,N-diethylaminoethyl (meth)acrylate, N-tert-butylaminoethyl (meth)acrylate, and the like; mono(meth)acrylates of aliphatic hydroxyl compounds such as ethylene glycol, methoxyethylene glycol, diethylene glycol, triethylene glycol, tetraethylene glycol, neopentyl glycol, 1,3-propanediol, 1,4-butanediol, 1,5-pentanediol, 1,6-hexanediol, 1,10-decanediol, tripropylene glycol, trimethylolpropane, pentaerythritol, dipentaerythritol, sorbitol, mannitol, tricyclodecane dimethanol, and the like or (meth)acrylates of alkylene oxide adducts thereof; di(meth)acrylates of bisphenol A, isocyanuric acid, ethylene glycol, and propylene glycol and di(meth)acrylates of alkylene oxide adducts of these alcohols; tri(meth)acrylates of pentaerythritol, trimethylolpropane, isocyanuric acid, and tri(meth)acrylates of alkylene oxide adducts of these alcohols; poly(meth)acrylates of pentaerythritol and dipentaerythritol; and the like.

Examples of the (meth)acrylamide compounds include (meth)acrylamide, N-butyl (meth)acrylamide, N,N-dimethyl (meth)acrylamide, and the like.

Examples of the styrene compounds include styrene, 4-bromostyrene, perfluorostyrene, α-methylstyrene, vinyltoluene, and the like.

Examples of the vinyl monomers include butadiene, isoprene, acrylonitrile, vinyl acetate, vinyl chloride, vinylidene chloride, N-vinylpyrrolidone, N-vinyl carbazole, vinyl pyridine, vinyl pyrrolidine, maleic anhydride, diallyl phthalate, and the like.

From the viewpoint of improving the refractive index of the polymer of the polymerizable monomer, the polymerizable monomer is preferably an acrylic acid ester compound having a polycyclic structure and more preferably an acrylic acid ester compound having a fluorene structure.

Examples of the polycyclic structure include a fluorene structure, a biphenyl structure, a bisphenol structure, and the like.

Examples of the acrylic acid ester compound having a fluorene structure include, but are not limited to, compounds having the following structures

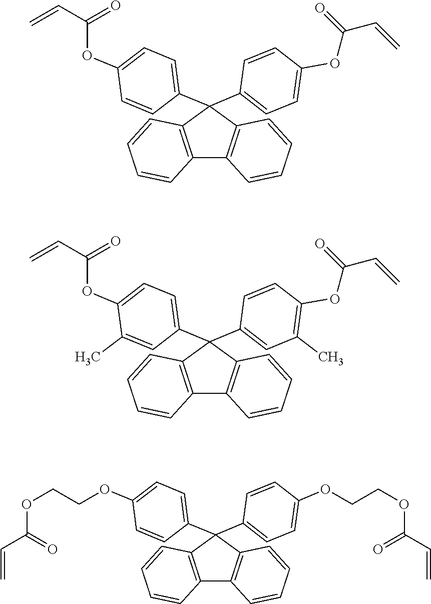

Besides these, ethoxylated bisphenol A diacrylate (A-BPE-4, manufactured by Shin-Nakamura Chemical Co., Ltd.) ethoxylated o-phenylphenol acrylate (A-LEN-10, manufactured by Shin-Nakamura Chemical Co., Ltd.), and the like can be used.

The polymerizable monomers may be used alone or in combination of two or more.

The content of the polymerizable monomer is preferably 5% by mass or more and 70% by mass or less and more preferably 10% by mass or more and 50% by mass or less relative to the total solid content of the composition for a hologram recording material according to the exemplary embodiment.

### <Photopolymerization Initiator>

A photopolymerization initiator which generates radicals or cations by light of 350 nm or more and 700 nm or less is used as the photopolymerization initiator.

The photopolymerization initiator is not particularly limited, and a known photopolymerization initiator can be used, but a radical polymerization initiator is preferred.

Examples of the radical polymerization initiator include a borate compound, a benzoin compound, an acetophenone compound, an anthraquinone compound, a thioxanthone compound, an acetal compound, a benzophenone compound, and the like.

Examples of the borate compound include tetrabutylammonium phenylhexyl borate, tetrabutylammonium butyltriphenyl borate, tetrabutylammonium trinaphthylbutyl borate, tetrabutylammonium tris(4-tert-butyl)phenylbutyl borate, tetrabutylammonium tris(3-fluorophenyl)hexyl borate, tetrabutylammonium tris(3-chloro-4-methylphenyl)hexyl borate, and the like.

Examples of the benzoin compound include benzoin, benzoin methyl ether, benzoin propyl ether, and the like.

Examples of the acetophenone compound include acetophenone, 2,2-dimethoxy-2-phenylacetophenone, 2,2-diethoxy-2-phenylacetophenone, 1,1-dichloroacetophenone, 1-hydroxycyclohexylphenyl ketone, 2-methyl-1-[4-(methylthio)phenyl]-2-morpholino-propan-1-one, N,N-dimethylaminoacetophenone, and the like.

Examples of the anthraquinone compound include 2-methylanthraquinone, 1-chloroanthraquinone, 2-amylanthraquinone, and the like.

Examples of the thioxanthone compound include 2,4-dimethylthioxanthone, 2,4-diethylthioxanthone, 2-chlorothioxanthone, 2,4-diisopropylthioxanthone, and the like.

Examples of the acetal compound include acetophenone dimethyl ketal, benzyl dimethyl ketal, and the like.

Examples of the benzophenone compound include benzophenone, methylbenzophenone, 4,4′-dichlorobenzophenone, 4,4′-bisdiethylaminobenzophenone, 1,3-di(tert-butyldioxycarbonyl)benzophenone, 3,3′,4,4′-tetrakis(tert-butyldioxycarbonyl)benzophenone, Michler's ketone, 4-benzoyl-4′-methyldiphenyl sulfide, and the like.

Other usable examples of the polymerization initiator include 2,4,6-trimethylbenzoyl diphenylphosphine oxide, N-phenylglycine, 2,4,6-tris(trichloromethyl)-s-triazine, 3-phenyl-5-isoxazolone, 2-mercaptobenzimidazole, imidazole dimers, bis(η5-2,4-cyclopentadien-1-yl)bis[2,6-difluoro-3-(1H-pyrrol-1-yl)phenyl]titanium, 5,7-diiodo-3-butoxy-6-fluorene, and the like.

The photopolymerization initiators may be used alone or in combination of two or more.

The content of the photopolymerization initiator is preferably 0.1% by mass or more and 30% by mass or less and more preferably 0.2% by mass or more and 10% by mass or less relative to the total solid content of the composition for a hologram recording material.

### <Sensitizer>

The composition for a hologram recording material according to the exemplary embodiment may further contain a sensitizer.

For example, when the borate compound is contained as the photopolymerization initiator, radical generation is accelerated by further containing the sensitizer which absorbs light at the wavelength used for interference exposure.

Examples of the sensitizer include, but are not limited to, polymethine-based compounds such as a cyanine-based dye, a styryl-based dye, and the like; xanthene-based compounds such as rhodamine B, rhodamine 6G, pyronine GY, and the like; phenazine-based compounds such as safranin O and the like; phenoxazine-based compounds such as cresyl violet, brilliant cresyl blue, and the like; phenothiazine-based compounds such as methylene blue and the like; diarylmethane-based compounds such as auramine and the like; triarylmethane-based compounds such as crystal violet, brilliant green, lissamine green, and the like; (thio)pyrylium salt-based compounds; squarylium-based compounds; and the like.

The sensitizers may be used alone or in combination of two or more.

The content of the sensitizer is preferably 0.01% by mass or more and 5% by mass or less and more preferably 0.01% by mass or more and 1% by mass or less relative to the total solid content of the composition for a hologram recording material.

### <Catalyst>

The composition for a hologram recording material according to the exemplary embodiment may contain a catalyst for, for example, accelerating the polymerization of a polymer precursor.

Examples of the catalyst include dibutyltin diacetate, dibutyltin dilaurate, dibutyltin maleate, and the like. Other examples include titanium and zirconium complex compounds such as tetraisopropoxytitanium, zirconium bis(acetylacetonate), and the like.

The catalysts may be used alone or in combination of two or more.

The content of the catalyst is preferably 0.001% by mass or more and 1% by mass or less and more preferably 0.005% by mass or more and 0.1% by mass or less relative to the total solid content of the composition for a hologram recording material.

### <Solvent>

The composition for a hologram recording material according to the exemplary embodiment may contain a solvent for, for example, improving coatability.

The solvent is not particularly limited, and any known solvent can be used as long as each of the components is dissolved or dispersed.

Examples of the solvent include, but are not limited to, methanol, ethanol, propanol, ethylene glycol monomethyl ether, 1-methoxy-2-propanol, 2-methoxyethyl acetate, 1-methoxy-2-propyl acetate, ethylene dichloride, cyclohexane, methyl ethyl ketone, dimethoxyethane, methyl lactate, ethyl lactate, N,N-dimethyl acetamide, N,N-dimethyl formamide, tetramethylurea, N-methylpyrrolidone, dimethyl sulfoxide, sulfolane, γ-butyrolactone, toluene, and the like.

The solvents may be used alone or in combination of two or more.

The content of the solvent is preferably 0.1% by mass or more and 30% by mass or less and more preferably 1% by mass or more and 10% by mass or less relative to the total mass of the composition for a hologram recording material.

### <Method for Producing Composition for Hologram Recording Material>

The composition for a hologram recording material according to the exemplary embodiment is produced by mixing the components.

The mixing method is not particularly limited, and a known method can be used.

In mixing, all components may be mixed at a time or some of the components may be mixed in advance and then mixed with the other components.

### (Hologram Recording Material)

The hologram recording material according to the exemplary embodiment is a hologram recording material produced by polymerizing the binder precursor contained in the composition for a hologram recording material according to the exemplary embodiment.

It is preferred that the polymerizable monomer in the hologram recording material is not polymerized.

The hologram recording material according to the exemplary embodiment is produced by, for example, applying the composition for a hologram recording material according to the exemplary embodiment on a substrate, drying the composition if required, and then polymerizing the contained binder precursor by heating.

A heating unit is not particularly limited, and a known heating unit can be used.

If required, a protective film may be further provided on the hologram recording material.

The hologram recording material according to the exemplary embodiment preferably contains the binder produced by polymerizing the binder precursor, the polymerizable monomer, and the photopolymerization initiator, and more preferably further contains the sensitizer. The components have the same meanings as those contained in the composition for a hologram recording material, and the preferred form is also the same as the composition for a hologram recording material.

Also, the hologram recording material may further contain a surfactant, a defoaming agent, a moisture removal agent, a photoacid generator, a photobase generator, a nano powder (silica, titania, zirconia, or the like), and a spacer material (plastic microbeads) for adjusting the thickness of a recording layer.

### <Characteristics of Hologram Recording Material>

The thickness of the hologram recording material is preferably 1 μm to 1000 μm and more preferably 10 μm to 500 μm.

In addition, from the viewpoint of producing the hologram recording material on which a hologram is easily recorded, the transmittance at the hologram recording wavelength preferably exceeds 1%.

The transmittance of the hologram recording material at the hologram recording wavelength is determined by using a spectrophotometer (Hitachi High-Technologies Corporation, U-4000).

### <Substrate>

The substrate used for forming the hologram recording material is not particularly limited, but a glass substrate, a sheet-shaped substrate, a film-shaped substrate, or the like is preferably used.

Examples of the material of the substrate include glass, transparent resin materials such as polyethylene terephthalate (PET), polycarbonate resin (PC), triacetyl cellulose resin (TAC), polyimide resin (PI), and the like.

The thickness of the substrate is not particularly limited, but is preferably 5 μm or more and 5000 μm or less and more preferably 15 μm or more and 3000 μm or less.

### <Protective Layer>

A resin film or the like is preferably used as the protective film.

Examples of the material of the resin film include a cycloolefin polymer (COP), PET, PC, TAC, PI, and the like.

The protective film is formed by attaching the resin to the hologram recording material formed.

The thickness of the resin film is not particularly limited but is preferably 5 μm or more and 500 μm or less and more preferably 15 μm or more and 300 μm or less.

### <Hologram Recording Medium>

The hologram recording medium according to the exemplary embodiment is a hologram recording medium produced by polymerizing the polymerizable monomer contained in the hologram recording material according to the exemplary embodiment.

The hologram recording medium according to the exemplary embodiment is produced by, for example, at least partially polymerizing the polymerizable monomer contained in the hologram recording material according to the exemplary embodiment by interference exposure of the hologram recording material.

The interference exposure of the hologram recording material is performed by, for example, using an exposure device described in Japanese Unexamined Patent Application Publication No. 2013-054070. Also, an apparatus produced by referring to description in J. Photopolym. Sci. Technol., Vol. 22, No. 2, p. 257, 2009 may be used.

A method known in the field of hologram recording can be used as an exposure method without any particular limit.

In addition, after the interference exposure, the unreacted monomer may be polymerized by exposure over the entire surface to fix a concentration gradient of the polymer in the hologram recording medium.

### Examples

Examples are described below, but the present invention is not limited to these examples. In a description below, “parts” and “%” are on a mass basis unless otherwise specified.

### <Preparation of Composition for Hologram Recording Material and Formation of Hologram Recording Material>

The components shown in Table 1 below are mixed at a ratio shown in Table 1 by using a magnetic stirrer to prepare a composition for a hologram recording material of each of examples and comparative examples. The composition is applied over the entire surface of a glass substrate of 10 cm×10 cm and then heated (baked) in an oven of 80° C. to form a hologram recording material. After baking, a protective film (thickness: 100 μm) of cycloolefin polymer (COP) is attached.

TABLE 1

| | Specific binder precursor | | | | | Polymerizable | | Photopolymerization | | |
|---|---|---|---|---|---|---|---|---|---|---|
| | | | | Crosslinking | Adding | monomer | Sensitizer | initiator | Solvent | Catalyst |
| | HDI | T-300 | PEG400 | species | amount | EA-200 | SO | P3B | NMP | DBTDL |
| Comparative | 2.073 | 0 | 4.928 | No | 0 | 3.000 | 0.015 | 0.070 | 0.500 | 0.001 |
| Example 1 | | | | | | | | | | |
| Example 1 | 2.072 | 0 | 4.904 | 200PA | 0.025 | 3.000 | 0.015 | 0.070 | 0.500 | 0.001 |
| Example 2 | 2.071 | 0 | 4.880 | 200PA | 0.049 | 3.000 | 0.015 | 0.070 | 0.500 | 0.001 |
| Example 3 | 2.068 | 0 | 4.784 | 200PA | 0.148 | 3.000 | 0.015 | 0.070 | 0.500 | 0.001 |
| Example 4 | 2.066 | 0 | 4.687 | 200PA | 0.247 | 3.000 | 0.015 | 0.070 | 0.500 | 0.001 |
| Comparative | 2.712 | 2.144 | 2.144 | No | 0 | 3.000 | 0.015 | 0.070 | 0.500 | 0.001 |
| Example 2 | | | | | | | | | | |
| Comparative | 2.721 | 2.139 | 1.925 | 40EM | 0.214 | 3.000 | 0.015 | 0.070 | 0.500 | 0.001 |
| Example 3 | | | | | | | | | | |
| Comparative | 2.730 | 2.135 | 1.708 | 40EM | 0.427 | 3.000 | 0.015 | 0.070 | 0.500 | 0.001 |
| Example 4 | | | | | | | | | | |
| Comparative | 2.715 | 0 | 3.114 | 3A-12PD | 1.071 | 3.000 | 0.015 | 0.070 | 0.500 | 0.001 |
| Example 5 | | | | | | | | | | |
| Comparative | 3.114 | 2.144 | 1.072 | 3A-12PD | 0.670 | 3.000 | 0.015 | 0.070 | 0.500 | 0.001 |
| Example 6 | | | | | | | | | | |

Each of the numerical values in Table 1 represents the amount (parts by mass) of each of the components used.

In Table 1, details of abbreviations are as follows.

HDI: hexamethylene diisocyanate (manufactured by Tosoh Corporation)

T-300: Actcol T-300 (manufactured by Mitsui Chemicals & SKC Polyurethanes, Inc.)

PEG400: polyethylene glycol 400 (average molecular weight 380 to 420, manufactured by Wako Pure Chemical Industries, Ltd.)

200PA: epoxyester 200PA (manufactured by Kyoeisha Chemical Co., Ltd.)

40EM: epoxyester 40EM (manufactured by Kyoeisha Chemical Co., Ltd.)

3A-12PD: 3-allyloxy-1,2-propanediol

EA-200: EA-200 (manufactured by Osaka Gas Chemicals Co., Ltd.)

SO: Safranin O (manufactured by Sigma-Aldrich Inc.)

P3B: tetrabutylammonium butyltriphenyl borate (manufactured by Showa Denko K. K.)

NMB: N-methylpyrrolidone (manufactured by Wako Pure Chemical Industries, Ltd.)

DBTDL: dibutyltin laurate (Tokyo Chemical Industry Co., Ltd.)

A hologram is recorded by using the hologram recording material of each of the examples and the comparative examples and a hologram recording apparatus described below, thereby producing a hologram recording medium.

The diffraction efficiency of the hologram recording medium is measured, and Δn is calculated (Table 2). In addition, Δn is calculated by the method described above.

### <Hologram Recording Apparatus>

A laser at a wavelength of 532 nm is used as a light source. The laser beam is made parallel light by using a spatial filter and a collimator lens and branched into object light and reference light by using a polarizing beam splitter. The object light and the reference light are made incident on difference surfaces of a sample.

The exposure amount is 1 mJ/cm² to 50 mJ/cm², and the incident angle is about 45°.

After the completion of exposure, the sample is exposed over the entire surface with an exposure amount of 1 J/cm².

TABLE 2

| | Crosslinking | Adding | |
|---|---|---|---|
| | species | amount | Δn |
| Comparative Example 1 | No | 0 | 0.015 |
| Example 1 | 200PA | 0.025 | 0.021 |
| Example 2 | 200PA | 0.049 | 0.021 |
| Example 3 | 200PA | 0.148 | 0.021 |
| Example 4 | 200PA | 0.247 | 0.021 |
| Comparative Example 2 | No | 0 | 0.011 |
| Comparative Example 3 | 40EM | 0.214 | 0.006 |
| Comparative Example 4 | 40EM | 0.427 | 0.004 |
| Comparative Example 5 | 3A-12PD | 1.071 | 0.013 |
| Comparative Example 6 | 3A-12PD | 0.670 | 0.004 |

The abbreviations in Table 2 are the same as in Table 1.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A composition for a hologram recording material, the composition comprising:
a binder precursor containing a compound having a structure represented by formula A below;
a polymerizable monomer; and
a photopolymerization initiator, 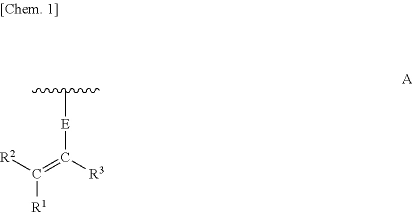
in the formula A, R¹ to R³ each represent a hydrogen atom or a substituent, E represents a divalent electron attracting group, a wavy line portion represents a bonding site with another structure, and when E is —C(═O)O—, R³ is not an alkyl group.

2. The composition for a hologram recording material according to claim 1, wherein the binder precursor contains a polyol compound and a polyisocyanate compound, and at least one of the polyol compound and the polyisocyanate compound contains a compound having a structure represented by the formula A.

3. The composition for a hologram recording material according to claim 2, wherein the polyol compound contains a compound having at least two hydroxyl groups and at least one (meth)acryloyloxy group.

4. A hologram recording material produced by polymerizing the binder precursor contained in the composition for a hologram recording material according to claim 1.

5. A hologram recording medium produced by polymerizing the polymerizable monomer contained in the hologram recording material according to claim 4.
